(19) United States
(12) Patent Application Publication
(10) Pub. No.: US 2008/0311031 A1
(43) Pub. Date: Dec. 18, 2008

(54) Methods For Production of Metal Oxide Nano Particles With Controlled Properties, and Nano Particles and Preparations Produced Thereby

(75) Inventors: Asher Vitner, Jerusalem (IL); Aharon Eyal, Jerusalem (IL)

Correspondence Address: LUCAS & MERCANTI, LLP, 475 PARK AVENUE SOUTH, 15TH FLOOR, NEW YORK, NY, 10016, US

(73) Assignee: JOMA INTERNATIONAL AS, Limingen (NO)

(21) Appl. No.: 12/096,157

(22) PCT Filed: Dec. 21, 2006
(86) PCT No.: PCT/IL06/01470

§ 371 Date: Jun. 4, 2008

(30) Foreign Application Priority Data
Dec. 27, 2005 (IL) 172838

(51) Int. Cl. C01B 13/14; C01F 7/02; C01G 9/02; C01G 19/02; C01G 45/02; C01G 3/02

(52) U.S. Cl. 423/604; 423/592.1; 423/625; 423/622; 423/618; 423/605

(57) ABSTRACT

The invention provides a method for the formation of small-size metal oxide particles, comprising the steps of a) preparing a starting aqueous solution comprising at least one of metallic ions and complexes thereof, at a concentration of at least 0.1 % w/w of the metal component; b) maintaining the solution at a temperature lower than 50° C. for a retention time in which hydrolysis takes place, the extent of the hydrolysis being sufficient to produce O.1 mmol protons per mmol of metal present in solution, wherein the time does not exceed 14 days, to form a system containing a retained solution; and c) adjusting the conditions in the system by at least one of the steps of: i) heating the retained solution to elevate the temperature thereof by at least 1° C.; ii) changing the pH of the retained solution by at least 0.1 units; and iii) diluting the retained solution by at least 20% whereby there are formed particles, wherein the majority of the particles formed are between about 2 nm and about 500 nm in size.

The present invention relates to a method for producing metal oxide nanoparticles and more particularly, to a method for producing metal oxide particles of desired particle size, particle size distribution and habit in an industrially and economically useful manner. In the present invention, the term metal oxide means and includes metal oxides of the formula MetalₓO_{y} (e.g. Al₂O₃, ZrO₂, ZnO, SnO, SnO₂, MnO, MnO₂, Cu₂O, CuO), metal hydroxy-oxides of the formula Metalₚ(OH)_{q}Oᵣ (e.g. Sn(OH)2, Sn(OH)₄, Al(OH)3, Si(OH)₄, Zn(OH)₂, CuOH, Cu(OH)₂, Mn(OH)₂Mn(OH)₄, Zr(OH)₄), metallic acid, various hydration forms thereof and compositions wherein these are major components, wherein x, y, p, q, r are each whole integers. Metal oxides are used in a wide range of applications, such as for abrasives, catalysts, cosmetics, electronic devices, magnetics, pigments & coatings, and structural ceramics, etc.

Abrasives—The nanoparticles exhibit superior effectiveness in critical abrasive and polishing applications when properly dispersed. The ultra-fine particle size and distribution of properly dispersed products is virtually unmatched by any other commercially-available abrasives. The result is a significant reduction in the size of surface defects as compared to conventional abrasive materials. The metal oxide nanoparticles are mainly used as general abrasives, rigid memory disk polishing, chemical mechanical planarization (CMP) of semiconductors, silicon wafer polishing, optical polishing, fiber optic polishing, and jewelry polishing. The main used products are aluminum oxide, iron oxide, tin oxide, and chromium oxide.

Catalysts—The metal oxide nanoparticles possess enhanced catalytic abilities due to their highly stressed surface atoms which are very reactive. Thus, they are mainly used as general catalysts (e.g. titanium dioxide, zinc oxide, and palladium), oxidation reduction catalysts (e.g. iron oxide), hydrogen synthesis catalysts (e.g. iron oxide titanium dioxide), catalyst supports such as substrates for valuable metals (e.g. aluminum oxide, and titanium dioxide), catalysts for emission control, catalysts for oil refining, and waste management catalysts.

Cosmetics—The metal oxide nanoparticles facilitate the creation of superior cosmetic products. They provide high UV attenuation without the use of chemicals, provide transparency to visible light when desired, and can be evenly dispersed into a wide range of cosmetic vehicles to provide non-caking cosmetic products. The metal oxide nanoparticles are mainly used as sunscreens, moisturizers with SPF (sun protection foundation), color foundations with SPF, lipstick with SPF, lip balm with SPF, foot care products, and ointments, The main products for cosmetic applications are zinc oxide powder, ZnO dispersions, FE45B (brown iron oxide), TiO₂ dispersions, black metal-oxide pigment, red metal-oxide pigment, metal-yellow oxide pigment, and metal-blue oxide pigment.

Electronic Devices—The metal oxide nanoparticles can provide new and unique electrical and conduction properties for use in existing and future technologies. The metal oxide nanoparticles are mainly used as varistors (e.g. zinc oxide), transparent conductors (indium tin oxide), high dielectric ceramics, conductive pastes, capacitors (titanium dioxide), phosphors for CRT displays (e.g. zinc oxide), electroluminescent panel displays (e.g. zinc oxide), ceramic substances for electronic circuits (e.g. aluminum oxide), automobile air bag propellant (e.g. iron oxide), phosphors inside fluorescent tubes (e.g. zinc oxide), and reflectors for incandescent lamps (e.g. titanium dioxide).

Magnetics—The metal oxide nanoparticles can provide new and unique magnetic properties for use in existing and future technologies. The metal oxide nanoparticles are mainly used as ferrofluids and magnetorheological (MR) fluids.

Pigments & Coatings—The metal oxide nanoparticles facilitate the creation of superior pigments and coatings. They provide high UV attenuation, transparency to visible light when desired, and can be evenly dispersed into a wide range of materials. The nanoparticles can also provide more vivid colors that will resist deterioration and fading over time. The metal oxide nanoparticles are mainly used as general pigments & coatings, microwave absorbing coatings, radar absorbing coatings, UV protecting clear coatings, antifungicide for paints, powder coatings, and automotive pigments (demisted on mica for metallic look).

Structural Ceramics—The metal oxide nanoparticles can be used in the production of ceramic parts. The ultra-fine size of the particles allows near-net shaping of ceramic parts via super plastic deformation, which can reduce production costs by reducing the need for costly post-forming machining. The metal oxides are mainly used as translucent ceramics for Arc-tube envelopes, reinforcements for metal-matrix composites, porous membranes for gas filtration, and net shaped wear resistant parts.

A lot of important nano-metal oxides powders have not yet been commercialized. The reported processes used to achieve nano-metal oxides are very expensive, have low yields and, most importantly, production scale up can be difficult.

Following are several methods described in the prior art for synthesizing metal oxide nanoparticles.

Gas-Phase Synthesis—A number of methods exist for the synthesis of nano-particles in the gas phase. These include gas condensation processing, chemical vapor condensation, microwave plasma processing and combustion flame synthesis. In these methods the starting materials are vaporized using energy sources such as Joule heated refractory crucibles, electron beam evaporation devices, sputtering sources, hot wall reactors, etc. Nano-sized clusters are then condensed from the vapor in the vicinity of the source by homogenous nucleation. The clusters are subsequently collected using a mechanical filter or a cold finger. These methods produce small amounts of non-agglomerated material, with a few tens of gram/hour quoted as a significant achievement in production rate.

Mechanical Attrition or Ball Milling—This method is a method that can be used to produce nano-crystalline materials by the structural decomposition of coarser-grained materials as a result of severe plastic deformation. The quality of the final product is a function of the milling energy, time and temperature. To achieve grain sizes of a few nanometers in diameter requires relatively long processing times or several hours for small batches. Another main drawback of this method is that the milled material is prone to severe contamination from the milling media.

Sol-Gel Precipitation-Based Synthesis—Particles or gels are formed by hydrolysis-condensation reactions, which involve first hydrolysis of a precursor, followed by polymerization of these hydrolyzed precursors into particles. By controlling the hydrolysis-condensation reactions, particles with very uniform size distributions can be precipitated. The disadvantages of sol-gel methods are that the precursors can be expensive, careful control of the hydrolysis-condensation reactions is required, and the reactions can be slow.

Methods based on Microemulsion—Microemulsion methods create nanometer-sized particles by confining inorganic reactions to nanometer-sized aqueous domains that exist within an oil. These domains, called water-in-oil or inverse microemulsions, can be created using certain surfactant/water/oil combinations. Nanometer-sized particles can be made by preparing two different inverse microemulsions that are mixed together, causing them to react with each other and thereby to form particles. The drawback of this method is that it produces small reaction volumes, thereby resulting in low production volumes, low yields, and an expensive process.

Surfactant/Foam Framework—In this process (as presented in U.S. Pat. No. 5,338,834 and U.S. Pat. No. 5,093,289) an ordered array of surfactant molecules is used to provide a “template” for the formation of the inorganic material. The surfactant molecules form a framework and deposit inorganic material onto or around the surfactant structures. The surfactant is then removed (commonly by burning out or dissolution) to leave a porous network that mimics the original surfactant structure. Since the diameter of the surfactant micelles can be extremely small, the pore sizes that can be created using the method are also extremely small, which leads to very high surface areas in the final product.

Precipitation—It is possible, in some special cases, to produce nano-crystalline materials by precipitation or co-precipitation if reaction conditions and post-treatment conditions are carefully controlled. Precipitation reactions are among the most common and efficient types of chemical reactions used to produce inorganic materials at industrial scales. In a precipitation reaction, typically, two homogenous solutions are mixed and an insoluble substance (a solid) is subsequently formed. Conventionally, one solution is injected into a tank of the modifying solution in order to induce precipitation. However, the control of this method is complicated and therefore properties such as uniform distribution of particle size and a specific particle size in the nano-scale, are hard to achieve.

The main objective of the present invention is to provide an industrial and economical process for producing nano-scale metal oxide particles of desired properties, e.g., uniform distribution of particle size, a specific particle size which may be changed according to customer demands, and nano-particles of a required crystal habit and structure.

Another objective of the present invention is to use precipitation for the production of nano-scale metal oxide particles, since this method is characterized by the most desirable properties, from the industrial point of view, of being a simple and inexpensive process. However, a further objective of the present invention is to make changes to the traditional process of producing nano-scale metal oxide particles, which will enable the controlling of the system and thereby achieve the strict demands of the market.

Still another objective of the present invention is to provide an industrial and economical process for the production of nano-scale metal oxide particles characterized by a low hydration level.

With this state of the art in mind, there is now provided, according to the present invention, a method for producing metal oxide particles in an aqueous solution, which comprises maintaining an aqueous metal salt solution, defined as the starting aqueous solution, at a temperature lower than 70° C. for a time sufficient to reduce the acidity of solution due to hydrolysis. The resulting solution, defined as the retained solution, is then subjected to a modification in temperature and/or dilution and/or addition of a reagent, thus modifying the pH of the solution to form a modified system. The preferred modification mode of said parameters is at a high rate.

In a second aspect of the present invention, there is provided raw material for producing other metal oxide particles by conventional methods such as heat-transformation of the obtained particles, calcination or ripening.

More specifically according to the present invention there is now provided a method for the formation of small-size metal oxide particles, comprising the steps of

a) preparing a starting aqueous solution comprising at least one of metallic ions and complexes thereof, at a concentration of at least 0.1% w/w of said metal component;

b) maintaining said solution at a temperature lower than 70° C. for a retention time in which hydrolysis takes place, the extent of said hydrolysis being sufficient to produce 0.1 mmol protons per mmol of metal present in solution, wherein said time does not exceed 14 days, to form a system containing a retained solution; and

c) adjusting the conditions in said system by at least one of the steps of:
i) heating the retained solution to elevate the temperature thereof by at least 1° C.;
ii) changing the pH of the retained solution by at least 0.1 units; and
iii) diluting the retained solution by at least 20%
   whereby there are formed particles, wherein the majority of the particles formed are between about 2 nm and about 500 nm in size.

The term metal as used in the present specification refers to a metal selected from the group consisting of tin, aluminum, zinc, copper, manganese, zirconium and a combination thereof.

The term metal oxide as used in the present specification refers to metal hydroxides, metal oxyhydroxides, metallic acids and combination thereof. In a preferred embodiment of the present invention said metal oxide as used in the present specification refers to substances selected from the group consisting of metal oxides of the formula MetalₓO_{y} (e.g. Al₂O₃, ZrO₂, ZnO, SnO, SnO₂, MnO, MnO₂, Cu₂O, CuO), metal hydroxy-oxides of the formula Metalₚ(OH)_{q}Oᵣ (e.g. Sn(OH)2, Sn(OH)₄, Al(OH)3, Si(OH)₄, Zn(OH)₂, CuOH, Cu(OH)₂, Mn(OH)₂Mn(OH)₄, Zr(OH)₄), metallic acid, various hydration forms of these and compositions wherein these are major components, wherein x, y, p, q, r are each whole integers.

In preferred embodiments of the present invention said solution is kept at said modified conditions for at least 0.5 minutes.

Preferably said modification of conditions is carried out over a period of up to 2 hours.

In preferred embodiments of the present invention, said process produces at least 50 kilograms of particles per hour.

Preferably said modification of conditions is carried out at a pressure of up to 100 atmospheres.

In preferred embodiments of the present invention said method is further characterized in that the majority of the formed particles have a degree of crystallinity of more than 50%.

Preferably said method is further characterized in that the size ratio between the smallest and largest particles of the mean 50% (by weight) of the formed particles is less than about 10, in especially preferred embodiments is less than about 5.

The term mean 50% (by weight), as used in the present specification refers to the 50% (by weight) of the particles, including 25% (by weight) of the particles which have a size that is larger than the mean size of the particles and 25% of the particles which have a size that is smaller than the mean size of the particles, whereas the larger 25% and the smaller 25% of the particles are closest in their size to the mean size in a standard statistical diagram that presents the size distribution of the formed particles.

Preferably said method is further characterized in that the majority of the formed particles are of a configuration other than elongated.

In preferred embodiments of the present invention said method is further characterized in that the majority of the formed particles have a configuration wherein the ratio between one dimension and any other dimension is less than about 3.

In other preferred embodiments of the present invention the majority of the formed particles are of an elongated configuration.

Preferably the majority of the formed particles have a surface area of at least 30 m²/gr.

Preferably the majority of the formed particles have a surface area of at least 100 m²/gr.

In especially preferred embodiments of the present invention said method further comprises the step of calcination, i.e., heating said formed particles to a temperature in a range of between about 90° C. and about 900° C. to form dehydrated particles.

In another preferred embodiment, the calcination step involves the dehydration of the produced particles.

In said preferred embodiments, said method preferably further comprises the step of removing part of the water in said particle suspension after said modifying of condition step and prior to, simultaneously with or after said dehydration.

In said preferred embodiments said dehydration is preferably conducted under super-atmospheric pressure.

In said preferred embodiments the temperature of said particle suspension is preferably elevated to said dehydration temperature over a period of up to 4 hours.

In said especially preferred embodiments the majority of the dehydrated particles are preferably of a configuration other than elongated.

In said especially preferred embodiments the majority of the dehydrated particles preferably have a surface area of at least 30 m²/gr.

In preferred embodiments of the present invention said preparation of a starting aqueous solution involves dissolution of a metal compound, addition of a base to the metal salt solution and acidulation of a metal salt solution.

In preferred embodiments of the present invention said preparation of an aqueous solution involves dissolution of a metal compound, addition of a base and acidulation of a metal salt solution.

In said preferred embodiments said metal compound is preferably selected from the group consisting of metal salts, metal oxides, metal hydroxides, metal minerals and combinations thereof. In the present invention the term metal complexes includes metal salts, metal complexes and metal hydroxides

Preferably said metal compound is selected from the group consisting of metal oxides, metal hydroxides, minerals containing the same and mixtures thereof, and said compound is dissolved in an acidic solution comprising an acid selected from the group consisting of sulfuric acid, nitric acid, hydrochloric acid, phosphoric acid, their acidic salts and combinations thereof.

In preferred embodiments of the present invention said prepared aqueous solution comprises an anion selected from the group consisting of sulfate, chloride, nitrate, phosphate, an organic acid and mixtures thereof.

In preferred embodiments of the present invention said modification comprises at least two heating steps.

In said preferred modification step at least one heating step is preferably conducted by contacting with a warmer stream selected from a group consisting of hot aqueous solutions, hot gases and steam.

In preferred embodiments said method preferably further comprises grinding formed particles.

In preferred embodiments said method preferably further comprises screening formed particles.

The present invention is also directed to metal oxide particles whenever formed according to the above-defined methods and products of their conversion.

The present invention is further directed to a preparation comprising said particles.

In preferred embodiments of said preparation said particles are preferably dispersed in a liquid, supported on a solid compound or agglomerated to larger particles.

In another aspect of the present invention there is provided a process for the production of a preparation as defined above comprising steps selected from the group consisting of dispersing said particles, addition of a support, heat treatment, mixing, water evaporation spray drying, thermal spraying and combinations thereof.

In especially preferred embodiments of the present invention said particles and preparations are used in the manufacture of paint.

In other preferred embodiments of the present invention said particles and preparations are used in the manufacture of a catalyst.

In another preferred embodiment of the present invention said adjusting stage comprises the steps of:

a) contacting the retained solution with a modifying solution in a continuous mode in a mixing chamber to form a modified system;

b) removing the modified system from the mixing chamber in a plug-flow mode

In especially preferred embodiments of the present invention the modified system stays in the mixing chamber for less than 5 seconds and in a more preferred embodiment the modified system stays in the mixing chamber for less than 0.5 seconds.

In preferred embodiments of the present invention, the mixing in the mixing chamber is carried out using the flow rate of the entering solution, by using a mechanical mode of mixing or another mode of mixing.

In preferred embodiments of the present invention the modified system exits the mixing chamber in a plug flow mode. In a more preferred embodiment the plug flow continues for more then 0.1 seconds and in a most preferred embodiment the plug flow continues for more then 5 seconds.

In preferred embodiments of the present invention the solution exiting the plug flow enters into a vessel. In a more preferred embodiment of the present invention the solution in the vessel is mixed.

### DETAILED DESCRIPTION OF THE INVENTION

The present invention will now be described in detail below.

The starting aqueous metal salt solution used in the present invention is preferably an aqueous metal salt solution comprising metallic ions or their complexes at a concentration of at least 0.1% w/w metal.

According to a preferred embodiment, the metal w/w concentration in the starting solution is at least 1%, more preferably at least 5%, and most preferably at least 10%. There is no upper limit to the concentration of the starting solution. Yet, according to a preferred embodiment, the concentration is below the saturation level. High viscosity is not desired according to another preferred embodiment. According to yet another preferred embodiment, the OH/Metal ratio in the solution is smaller than 2. According to a preferred embodiment, the temperature of the prepared starting solution is less than 70° C.

Any source of metal is suitable for preparing the starting solution of the present invention, including metal containing ores, fractions of such ores, products of their processing, metal salts or metal containing solutions such as aqueous solution exiting metal containing ores.

According to a preferred embodiment, step (b) is conducted shortly after both the desired concentration and pH are achieved. According to another preferred embodiment, the solution used in step (b) is prepared within a short time and does not contain metallic ions or their complexes, which were prepared at different times and then mixed together. For a similar reason, extended preparation time is not desired. According to a preferred embodiment, preparation time is shorter than 20 hours, preferably shorter than 10 hours, most preferably shorter than 2 hours. In cases wherein an older solution exists (e.g. a recycled solution) and is to be mixed with a fresh solution to form the starting solution, the older solution is first acid treated, as described hereinafter.

The freshly prepared metallic salt solution may contain any anion, including chloride, sulfate, nitrate phosphate, carboxylate, organic acid anions, and various mixtures thereof. According to a preferred embodiment, the freshly prepared solution comprises metallic sulfate. According to another preferred embodiment, the salt is of an organic acid.

A freshly prepared salt solution for use in the process of the present invention may be a solution that was produced in natural conditions, (such as solutions exiting mines with metal containing ores) or a solution that was prepared by artificial methods including chemical or biological oxidations. Such a solution could be prepared by various methods or their combinations, including dissolution of metallic salts, dissolution of metal salts, dissolution of double salts, dissolution of metal oxide-containing ores in an acidic solution, dissolution of scrap metal in oxidizing solutions, such as solutions of metallic salt, nitric acid, etc., and leaching of metal-containing minerals.

Preparation of the aqueous solution is conducted in a single step, according to a preferred embodiment. According to an alternative embodiment, the preparation comprises two or more steps. According to another embodiment, a concentrated solution of metallic salt is prepared, e.g. by dissolution of a salt in water or in an aqueous solution. While momentarily and/or locally, during the dissolution, the required pH and concentration of the starting solution are reached, typically the pH of the formed concentrated solution after at least partial homogenization, is lower than desired for the starting solution. According to a preferred embodiment, such momentary reaching of the desired conditions is not considered preparation of the starting solution. The pH of the concentrated solution is then brought to the desired level by any suitable means, such as removal of an acid, addition and/or increasing the concentration of a basic compound, or a combination thereof. The formation of the starting solution in this case is considered the adjustment of the pH to the selected range, according to a preferred embodiment, and the pH of the starting solution is the one obtained after at least partial homogenization, according to another preferred embodiment. According to still another preferred embodiment, a concentrated solution is prepared and the pH is adjusted to a level that is somewhat lower than desired. The starting solution is then prepared by dilution of the solution, which increases the pH to the desired level. Here again, the pH of the starting solution is the one obtained after at least partial homogenization, according to a preferred embodiment. The same is true for other methods of multi-stage preparation of the starting solution, e.g, as in the case of forming a solution of a metallic salt.

According to a preferred embodiment, the starting solution is freshly prepared. According to another preferred embodiment, the solution does not comprise ions and/or complexes prepared at different times, as in the case of mixing a recycled solution with a freshly prepared one. At pH lower than the pKa value of the metal by one pH unit, (pKa −1), and low temperatures (e.g. lower than 40° C.), a solution maintains its freshness for a longer time, and could serve as a stock solution, according to a preferred embodiment. At other conditions, the solution is not considered fresh after a few hours or a few days, according to another preferred embodiment. According to a preferred embodiment, freshness of the solution is regained by acid treatment. Such less fresh solution is acidulated to pH lower than (pKa−1.5), preferably to a pH lower than (pKa −2) and is preferably mixed, agitated or shaken for at least 5 min, before increasing the pH back to the initial value to reform a fresh solution. Such reformed fresh solution is mixed with other fresh solution according to a preferred embodiment.

The term pKa of the metal as used in the present invention refers to the logarithmic value of the hydrolysis constant of the metal, Ka, in relation to the following reaction:

M^{x}+H₂O [symbol] (MOH)^{x-1}+H⁺;

while

Ka=[(MOH)^{x-1}]*[H⁺]/[M^{x}]*[H₂O];

wherein, M refers to the metal and X or X−1 to the valiancy.

In the next step of the process, the metallic solution is preferably retained at a temperature lower than 70° C. for a retention time that doesn't exceed 14 days. During the retention time, hydrolysis takes place. According to a preferred embodiment, the retention time is the time needed to produce at least 0.1 millimol H⁺ (protons) in solution per one millimol of metal. According to still another preferred embodiment, in cases wherein a base or a basic compound is added to the solution during the retention time, the retention time is the time that would have been needed to form those amounts of protons with no base addition.

According to a preferred embodiment, the retention time decreases with increasing pH of the prepared solution. Thus, e.g. at pH lower than pKa of the metal, the retention time is preferably from 20 min to few days. At pH of between (pKa+1) of the metal to (pKa+4) of the metal, the retention time is preferably less than 1 day. In cases of varying pH during the retention time, the latter is affected by the maximal pH reached. Typically, retention time decreases with increasing temperature of the solution.

The third step needed in order to achieve the above mode of precipitation, is modifying the conditions of the solution to achieve at least one of an increase in pH and/or temperature and/or dilution of the solution.

The modification of conditions is preferably done in a short time and the modified conditions are maintained for a short time. The duration at the modified conditions is less than 24 hours, according to an exemplary embodiment, preferably less than 4 hours, more preferably less than 2 hours, and most preferably less than 10 minutes. In other preferred embodiments of the present invention, the modification of conditions is conducted within 2 hours, preferably within 10 minutes, more preferably within 1 minute.

Increasing the pH in step (c) can be achieved by any known method, such as the removal of an acid, or the addition of or increasing the concentration of a basic compound. Acid removal can be conducted by known methods, such as extraction or distillation. Any basic compound could be added. According to a preferred embodiment, a basic compound is a compound that is more basic than metallic salt, as measured by comparing the pH of their equi-molar solutions. Thus, such a basic compound, is preferably at least one of an inorganic or organic base or precursor of a base, e.g., an oxide, hydroxide, carbonate, bicarbonate, ammonia, urea, etc. Such methods of increasing pH are also suitable for use in step (a) of preparing the starting solution. According to a preferred embodiment, basic pH is avoided through most of the process, so that during most of the duration of the pH increase in step (c), the pH is acidic, or slightly acidic.

According to another preferred embodiment the pH in step (a) is decreased by addition of an acid. According to a preferred embodiment the anion of the acid is the same anion present in the metal salt but other anions can also be used.

According to another preferred embodiment, the solution is diluted in step (c). According to a preferred embodiment, the solution is diluted to 80% of its initial value, more preferably to at least 50%, and most preferably by at least 33% of the initial value.

According to another preferred embodiment, the temperature of the solution is increased. According to a preferred embodiment, the temperature is increased by at least 10° C., more preferably by at least 30° C., even more preferably by at least 50° C., and most preferably by at least 80° C. Temperature increase can be affected by any known method, such as contact with a hot surface, with hot liquid, with hot vapors, infra-red irradiation, microwaving or any combination thereof.

According to another preferred embodiment two or all three of the modifications are conducted sequentially or simultaneously. Thus, according to a preferred embodiment, the basic compound is added to the solution of the metallic salt after the retention time, in said modifying aqueous solution, which also dilutes the metallic salt. According to another preferred embodiment, the solution of the metallic salt is contacted with a diluting solution comprising water and/or an aqueous solution, which is of a temperature greater than the solution of the metallic salt solution by at least 50° C. according to a first preferred embodiment, and preferably by at least 100° C. According to an alternative embodiment, the temperature of said diluting solution is between about 100° C. and 250° C., and between 150° C. and 250° C., according to another preferred embodiment. According to yet another preferred embodiment, the diluting solution comprises a reagent that interacts with metallic ions, their complexes and/or with particles thereof.

According to still another preferred embodiment, the metallic salt solution after the retention time, is combined in step (c) with a modifying aqueous solution comprising a solute that is more basic than the metallic salt, which modifying aqueous solution is at a temperature greater than the solution of the metallic salt. According to a preferred embodiment, the metallic salt solution and said modifying aqueous solution are mixed, e.g. mechanically, in suitable equipment that provides for strong mixing, to rapidly achieve a homogenous system. In cases where the temperature of at least one of these solutions is above boiling point, the mixing equipment is preferably selected so that it withstands super-atmospheric pressure. According to a preferred embodiment, the mixing is conducted by contacting flowing metallic salt solution with flowing modifying aqueous solution, e.g. in a plug-flow mode. Preferably, the mixed stream is kept at the formed temperature or at another temperature obtained by cooling or heating for a short duration, less than 1 day according to an exemplary embodiment, preferably between 1 and 60 minutes, and even more preferably between 0.5 and 15 minutes.

The degree of heating, pH elevation and dilution, when conducted as a single means for modification or in combination, affects the chemical nature of the formed particles. For example, typically, the higher the temperature, the lower the degree of hydration of the particle components. The crystal form and shape are also affected.

According to a preferred embodiment, the final product oxide is formed in step (c) of the process. According to another preferred embodiment, the product of step (c) is further processed and transformed into the desired final product.

Such further processing comprises heating, according to a preferred embodiment. Preferably heating is to a temperature in the range of between about 90° C. and 900° C. According to a preferred embodiment, heating is of a solution comprising the formed particles as obtained in step (c), or after some treatment, e.g. partial or full removal of water. According to another preferred embodiment, the formed particles are first separated from the solution. The separated particles could be treated as they are, or after further treatment, e.g. washing and/or drying. Heating in solution is preferably done at a super-atmospheric pressure and in equipment suitable for such pressure. According to a preferred embodiment, an external pressure is applied. The nature of heating is also a controlling factor, so that the result of gradual heating is in some cases different from rapid heating. According to a preferred embodiment, step (c) and further heating are conducted sequentially, preferably in the same vessel.

The crystal habit of the transformed particles is of the general habit of the origin particles from which it was produced, according to a preferred embodiment. For example rod-like particles can be transformed to elongated particles.

In another embodiment of the present invention amorphous metallic acid particles with low particle dimension ratio can be transformed to particles with high dimension ratio.

In another embodiment of the present invention, agglomerates with rod-like habit or agglomerates of spherical habit can be transformed into particles with rod-like habit or agglomerates with spherical habit, respectively.

As will be realized the present invention provides conditions for the production of precipitates which are easy to transform, and as well provides a transformation product with superior properties.

According to a preferred embodiment, at least one dispersant is present in at least one of the method steps. As used herein, the term dispersant means and includes dispersants, surfactants, polymers and Theological agents. Thus, a dispersant is introduced into a solution in which a metallic salt is dissolved or is to be dissolved, or is added to a precursor of the solution, such as a mineral ore, according to a preferred embodiment. According to another preferred embodiment, a dispersant is added to the solution during the retention time or after it. According to an alternative embodiment, a dispersant is added to the solution prior to the adjustment step or after such step. According to still another preferred embodiment, a dispersant is added prior to a transforming step, during such step or after it. According to another preferred embodiment, the process further comprises a step of modifying the concentration and/or the nature of the dispersant during the process, and/or adding another dispersant. According to a preferred embodiment, suitable dispersants are compounds having the ability to be adsorbed on the surface of nanoparticles and/or nuclei. Suitable dispersants include cationic polymers, anionic polymers, nonionic polymers, surfactants poly-ions and their mixtures. In the present specification the term “dispersant” relates to molecules capable of stabilizing dispersions of the formed particles, and/or modifying the mechanism of formation of the nanoparticles, and/or modifying the structure, properties and size of any species formed during the process of formation of the nanoparticles.

According to a preferred embodiment, said dispersant is selected from a group consisting of polydiallyl dimethyl ammonium chloride, sodium-carboxy methyl cellulose, poly acrylic acid salts, polyethylene glycol, and commercial dispersants such as Solsperse® grade, Efka® grades, Disperbyk® or Byk® grades, Daxad® grades and Tamol® grades.

According to a preferred embodiment, the process further comprises a step of ultrasound treating the solution during or after at least one of the process steps.

According to a preferred embodiment, the process further comprises a step of microwave treating the solution during or after at least one of the process steps.

According to a preferred embodiment, further processing comprises partially fusing particles to particles of greater size. According to another preferred embodiment, aggregates of the particles are mechanically treated for comminuting.

The product of the present invention, as formed in step (c) or after further transformation, is preferably small-size particles of metal oxide. The size of the particles is in the range between 2 nm and 500 nm, according to a preferred embodiment. According to another preferred embodiment, the size distribution of the product particles is narrow so that the size ratio between the smallest and biggest particle of the mean 50% (by weight) of the formed particles is less than about 10, more preferably less than 5, most preferably less than 3.

Separate particles are formed according to a preferred embodiment. According to another embodiment, the formed particles are at least partially agglomerated.

According to a preferred embodiment, the majority of the formed particles have a degree of crystallinity of more than 50% as determined by X-ray analysis.

According to a preferred embodiment, the shape of the particles formed in step (c) or after further transformation, is elongated, such as in needles, rods or rafts.

According to another preferred embodiment, the particles are spherical or nearly spherical, so that the majority of the formed particles have a configuration wherein the ratio between one dimension and any other dimension is less than about 3.

According to a preferred embodiment, the majority of the formed particles have a surface area of at least 30 m2/gr, more preferably at least 100 m2/gr. High surface area particles of the present invention are suitable for use in catalyst preparation.

The process of the present invention is capable of forming highly pure metal oxide from a precursor of relatively low purity, such as a metal ore. According to a preferred embodiment, the purity of the metal oxide product with regard to other metals intermixed therewith, is of at least 95%, more preferably at least 99%.

According to another preferred embodiment, the metal oxide particles are doped with ions or atoms of other transition metals.

According to a preferred embodiment, the particles are obtained in a form selected from a group consisting of particles dispersed in a liquid, particles supported on a solid compound, particles agglomerated to larger particles, partially fused particles, coated particles, or a combination thereof.

The particles, their preparation and/or products of their conversion are suitable for use in many industrial applications, such as in the production of pigments, catalysts, coatings, thermal coatings, etc. The particles are used in these and other applications as such in a first embodiment. According to another preferred embodiment, said particles are further processed, and according to yet another preferred embodiment said particles are formed as part of preparing material for such application.

Many of the processes described in the literature are suited for use in laboratories, and are not highly practical for commercial use. They start with a highly pure precursor, work with a highly dilute solution, and/or are at a low volume and rate. The method of the present invention is highly suitable for economically attractive industrial scale production. According to a preferred embodiment, the method is operated at a production rate of at least 50 Kg/hour, more preferably at least 500 Kg/hour.

According to a preferred embodiment the pH of the solution drops during the process due to the hydrolysis of the metallic salt and thereby formation of an acid, e.g. sulfuric acid is achieved. Such acid is reused according to a preferred embodiment, e.g. for the formation of the metallic salt solution, e.g. in dissolution of a metal-containing mineral According to another preferred embodiment, the formed acid is partially or fully neutralized during the process, thereby forming a salt of the acid. According to a preferred embodiment, the salt is of industrial use, e.g., as in the case where neutralization is preformed with ammonia to form ammonium salts, which are suitable for use as fertilizers.

In another preferred embodiment of the present invention said adjusting stage comprises the steps of:

a) contacting the retained solution with a modifying solution in a continuous mode in a mixing chamber to form a modified system; and

b) removing the modified system from the mixing chamber in a plug-flow mode

The temperature of the modified system is determined by the temperatures of the starting solution and of the hot modifying solution, by their heat capacity and by their relative amounts. According to a preferred embodiment, the temperature of the modified system is maintained with minimal change, e.g. with no changes in either direction that is greater than 20° C. According to a preferred embodiment the modified system is retained at that temperature for a duration of between 1 and 30 minutes, more preferably between 3 and 15 minutes.

A modifying aqueous solution of a temperature greater than 80° C. and the starting solution are contacted in a continuous mode in a mixing chamber to form a modified system. The mixing chamber is built in a way to ensure quick and efficient mixing of the solutions. The modified system is removed from the mixing chamber in a plug-flow mode. During the plug flow, the precipitation is completed. In another preferred embodiment the solution is not exhausted during the plug flow time and the precipitation continues in another vessel.

The mixing in the mixing chamber is preferably carried out using the flow rate of the entering solution, by using mechanical mixing means or by another mode of mixing.

In one preferred embodiment, the temperature in the mixing chamber and during the plug flow are similar. In another preferred embodiment the temperature of the solution during the plug flow is higher than that in the mixing chamber and in yet another preferred embodiment the temperature of the solution during the plug flow is lower than that in the mixing chamber.

In a preferred embodiment of the present invention a solution containing a compound selected from the group consisting of an acid and a base is added to at least one of the solutions selected from the group consisting said starting solution, modifying solution and modified system.

In a preferred embodiment of the present invention, the residence time in a mixing chamber is less than about 5 minutes and more preferred is a residence time of less than 1 minute. In an even more preferred embodiment, the residence time in a mixing chamber is less than about 5 seconds and in an especially preferred embodiment the residence time is less than 0.5 seconds.

In preferred embodiments of the present invention the solution exiting the plug flow enters into a vessel. In a more preferred embodiment of the present invention the solution in the vessel is mixed.

In a preferred embodiment of the present invention the solution exiting the plug flow or the produced particles present in the solution exiting the plug flow are introduced into a crystallizer.

In another preferred embodiments of the present invention the temperature inside the crystallizer is kept in the range of about 100-300° C.

In preferred embodiments of the present invention a metal salt solution is also introduced into a crystallizer.

In another preferred embodiments of the present invention metallic acid is also introduced into a crystallizer.

It will be evident to those skilled in the art that the invention is not limited to the details of the foregoing description and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1-61. (canceled)

62. A method for the formation of small-size metal oxide particles, comprising the steps of:
a) preparing a starting aqueous solution comprising at least one of metallic ions and complexes thereof, at a concentration of at least 0.1% w/w of said metal component;
b) maintaining said solution at a temperature lower than 50° C. for a retention time in which hydrolysis takes place, the extent of said hydrolysis being sufficient to produce 0.1 mmol protons per mmol of metal present in solution, wherein said time does not exceed 14 days, to form a system containing a retained solution; and
c) adjusting the conditions in said system by at least one of the steps of:
i) heating the retained solution to elevate the temperature thereof by at least 1° C.;
ii) changing the pH of the retained solution by at least 0.1 units; and
iii) diluting the retained solution by at least 20%;
whereby there are formed particles, wherein the majority of the particles formed are between about 2 nm and about 500 nm in size and optionally, further comprising the step of dehydrating said formed particles at a calcination temperature in a range of between about 90° C. and about 900° C. to form dehydrated particles.

63. A method according to claim 62, wherein the solution is maintained at said adjusted conditions for at least 0.5 minute.

64. A method according to claim 62, wherein said adjustment of conditions is carried out during less than 2 hour.

65. A method according to claim 62, further characterized in that the majority of the formed particles have a degree of crystallinity of more than 50%.

66. A method according to claim 62 further characterized in that the size ratio between the smallest and largest particle of the mean 50% by weight of the formed particles is less than about 5.

67. A method according to claim 62, wherein said dehydration step and said adjusting step are conducted simultaneously and wherein adjusting involves heating to calcination temperature.

68. A method according to claim 62, wherein said metal is selected from the group consisting of aluminum, zirconium, zinc, tin, manganese, copper and a combination thereof and wherein said metal oxide is selected from the group consisting of metal oxides of the formula MetalₓO_{y}, metal hydroxy-oxides of the formula Metalₚ(OH)_{q}Oᵣ, metallic acid, various hydration forms of these and compositions wherein these are major components, wherein x, y, p, q, r are each whole integers.

69. A method according to claim 62, wherein said metal compound is selected from the group consisting of metal salt, metal oxides, metal hydroxides, minerals containing said metal compound and mixtures thereof and wherein said compound is dissolved in an acidic solution comprising an acid selected from the group consisting of sulfuric acid, nitric acid, hydrochloric acid, phosphoric acid, an organic acid, their acidic salts and combinations thereof.

70. A method according to claim 62, wherein at least one dispersant is present in at least one step of a group consisting of preparing, maintaining, adjusting, dehydrating and grinding, wherein said dispersant is selected from a group consisting of cationic polymers, anionic polymers, nonionic polymers, surfactants, and mixtures thereof, and wherein the method further comprising the step of modifying the amount of said dispersant.

71. A method according to claim 62, wherein the starting solution is treated by at least one of the following actions of ultrasound and microwaving.

72. The metal oxide particles whenever formed according to the method of claim 62, a product of their conversion and a preparation comprising them.

73. The metal oxide particles of claim 72, characterized in at least one of:
(i) that the purity of said metal oxide particles with regard to other metals intermixed therewith, is of at least 95%; and
(ii) that said particles are doped with atoms of other compounds.

74. A preparation according to claim 72, wherein said particles are modified by a modification process selected from a group consisting of dispersion in a liquid, being supported on a solid compound, agglomeration to larger particles, partial fusion, being coated, and a combination thereof.

75. A method comprising using at least one of said particles and said preparations according to claim 72 as at least one of a pigment, a catalyst and a coating.

76. Industrial production of particles according to claim 62, wherein particles are formed at a rate of at least 50 Kg/hour.

77. Sew) A method according to claim 62, wherein the adjusting stage comprises the steps of:
a) contacting the retained solution with a modifying solution in a continuous mode in a mixing chamber to form a modified system; and
b) removing the modified system from the mixing chamber in a plug-flow mode.

78. A method according to claim 77, wherein the residence time in the mixing chamber is less than about 5 minutes.

79. A method according to claim 62, wherein the temperature of the modifying solution is in the range between 100° C. and 300° C.

80. A method according to claim 62, wherein the modified system is retained for a duration of between 1 and 60 minutes and wherein the temperature is maintained within less than 20° C. change in either direction from the temperature of the modified system.

81. A method according to claim 77, where the residence time in the mixing chamber is less than about 5 seconds.

82. A method according to claim 77, wherein the removed modified system or the particles therein and optionally also a metal salt solution or a metallic acid are introduced into a crystallizer, wherein the temperature is kept in the range of about 100-300° C.

83. A method according to claims 62 wherein a reagent selected from the group consisting of a dispersant and a basic compound, is present in at least one step of a group consisting of preparing, maintaining, adjusting, crystallizing in said crystallizer, and flowing in said plug-flow mode.

84. A method according to claim 62, wherein at least one of said starting solution and said modifying solution comprise a reagent selected from the group consisting of dispersants and basic compounds and wherein said basic compound is selected from the group consisting of ammonia, ammonium carbonate, ammonium bicarbonate and urea.
